(19) United States
(12) Patent Application Publication
(10) Pub. No.: US 2003/0016732 A1
(43) Pub. Date: Jan. 23, 2003

(54) Communications networks

(76) Inventors: Gyorgy Miklos, Budapest (HU); Zoltan Turanyi, Budapest (HU); Andras Valko, Budapest (HU)

Correspondence Address: Stanley R. Moore, Esq., Jenkens and Gilchrist, P.C., 3200 Fountain Place, 1445 Ross Ave., Dallas, TX, 75202, US

(21) Appl. No.: 10/131,756

(22) Filed: Apr. 22, 2002

(30) Foreign Application Priority Data
Apr. 27, 2001 (GB) 0110397.7

(51) Int. Cl. H04B 1/713

(52) U.S. Cl. 375/132

(57) ABSTRACT

Neighbour discovery in communications networks is made possible by a node sending beacon packets which include information regarding the node. The beacon packets are sent at pseudo-random time and on pseudo-random frequencies.

The present invention relates to communications networks.

### BACKGROUND OF THE INVENTION

The present invention concerns radio frequency communication protocols such as the short range protocol known as Bluetooth (see Bluetooth specification 1.1). In such a system, nodes (or devices) establish a common channel known as a “piconet”. The devices in a piconet follow a common frequency hopping sequence. This helps intra-piconet communication and provides a good separation between devices belonging to different piconets. At the same time, it makes the problem of neighbour discovery difficult because new neighbours are not necessarily synchronised to the frequency hopping sequence of the piconet. In this description neighbours are defined as being nodes that are within radio range of one another.

The Bluetooth specification solves the problem of neighbour discovery by introducing the inquiry and inquiry scan states. Nodes performing neighbour discovery enter to the inquiry state and transmit a short packet repetitively on the inquiry hopping sequence. Nodes that are discoverable may enter the inquiry scan state and follow the inquiry scan hopping sequence. The inquiry scan hopping sequence is a slower hopping sequence than the inquiry sequence, and it is defined so that the two nodes are guaranteed to use the same frequency in the procedure at some point in time. When the same frequency is used and the inquiring packet is received correctly, a response is sent back to the node performing the neighbour discovery, following a simple random wait scheme to avoid collisions.

While the solution in the Bluetooth specification is suitable for applications when neighbour discovery is only seldom needed, such as typical cable replacement applications, it is not suitable in a dynamic environment when neighbour discovery needs to be performed more often. The problem with the existing solution is that it requires a high overhead. It takes at least 10.24 seconds to perform the complete inquiry procedure in the best case, which is not acceptable in a networking application when the set of neighbours changes and needs to be updated quickly. More specifically, the solution does not support neighbour discovery for a node that is actively transmitting or receiving traffic.

Furthermore, the solution assumes asymmetrical roles: one of the two nodes performs inquiry, the other one of the two nodes performs inquiry scan. This is suitable in many applications where the roles of the devices are different (eg. Laptop PC and printer), but it is not suitable for a networking scenario with peer nodes (ie. nodes having similar functions, eq. two laptop PC's).

### SUMMARY OF THE PRESENT INVENTION

In accordance with the present invention, neighbour discovery is made possible by sending beacon packets at pseudo-random time slots and pseudo-random frequencies. To discover or update the status of its neighbours, a node needs to scan for the beacon packets of its neighbours. The scanning does not need to be continuous, making it possible to perform neighbour discovery even when a node is active sending or receiving data. While this neighbour discovery procedure does not guarantee 100% probability of discovery in a predetermined amount of time, it results in a flexible mechanism that discovers all the neighbours with a probability that exponentially grows to 100% with the time spent with scanning.

It is to be noted that although the present invention is described in terms of the Bluetooth system, the principles are clearly applicable to other radio technologies. Specifically the present invention is applicable to other systems using frequency hopping radio technology. The use of Bluetooth is merely exemplary.

It is emphasised that the term “comprises” or “comprising” is used in this specification to specify the presence of stated features, integers, steps or components, but does not preclude the addition of one or more further features, integers, steps or components, or groups thereof.

### BRIEF DESCRIPTION OF THE DRAWINGS

FIG. 1 is a schematic diagram illustrating a network in a wireless communications system;

FIG. 2 is a flow diagram illustrating a method embodying the present invention;

FIGS. 3 and 4 illustrate transmission of beacon packets; and

FIGS. 5 and 6 are respective graphs illustrating neighbour detection in accordance with the present invention.

### DESCRIPTION OF THE PREFERRED EMBODIMENTS OF THE PRESENT INVENTION

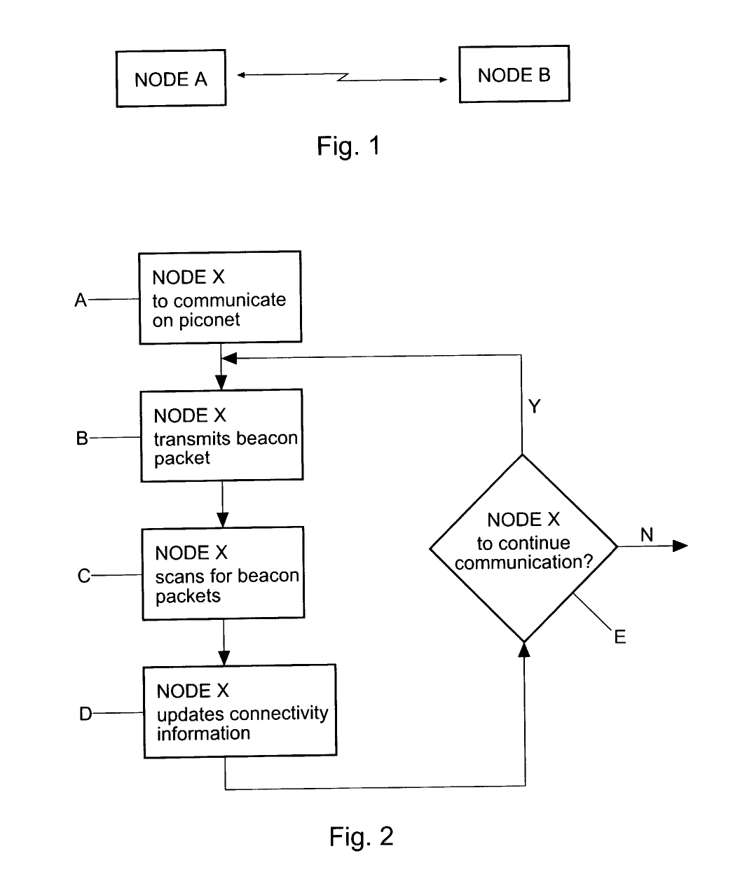

FIG. 1 is a schematic diagram illustrating a simple wireless network in a wireless communications system. Two nodes, node A and node B are able to communicate with one another via a radio frequency (RF) interface. Embodiments of the present invention are concerned with the creation and maintenance of such wireless networks, particularly in situations where nodes are mobile and able to communicate on many possible communication channels on an ad hoc basis. One such system is the Bluetooth (TM) system and the present invention will be described with reference to the Bluetooth system, but it will be readily appreciated that the invention is applicable to any RF communications system, in particular packet-based communications systems, or frequency-hopping communications systems when information about neighbours is not readily available.

FIG. 2 is a flow diagram illustrating a method in accordance with one aspect of the present invention. The method is applicable to the network illustrated in FIG. 1 and is concerned with the operation of a node of that network. This node is referred to as node X in FIG. 2. In the case of a new node that wishes to communicate in a piconet, at step A the node commences the procedure, and at step B, transmits a beacon packet, as will be described below, to the members of the piconet.

At step C, the node scans for beacon packets transmitted by the other members of the piconet, and using information from those beacon packets updates the connectivity information that the node holds (step D).

A new node may not wish to be discovered itself, but may only wish to discover its neighbours. In that case, the node will simply scan for neighbour beacon packets, and will not send beacon packets itself.

Alternatively, a new node may not wish to discovers its neighbours, but may wish to be discoverable. In that case the node would simply transmit beacon packets, but not scan for beacon packets from other nodes.

The node can then continue to communicate on the piconet, or could stop communication on the piconet without any further action being taken.

The beacon packets are sent in order to make the sending node discoverable and allow its neighbours to update their status information. The timing and frequency of the beacon packets are defined with respect to the piconet of which the node is a member. The piconet where the node is a permanent member is referred to as its home piconet.

A beacon packet may include the following information: the MAC address of the node, information which defines the timing and frequency of future beacon packet transmission and optional additional status information. In one specific example, home piconet hopping sequence information in the form of the address of the master node of the home piconet together with the clock of the master node is included, since this information determines the home hopping sequence and can be used to define the timing and frequency of future beacon packet transmission.

The following describes one example of beacon slot selection. Note that this is only one of many possibilities. The basic requirement for selecting the beacon slots is that they have to be predictable from the information sent in the beacon packet, yet at the same time they must be distributed in a pseudo-random fashion. In the example solution, the concept of beacon periods is used. Beacon periods are consecutive periods of length T_{BCN} where T_{BCN} is a power of two multiple Tₛ (slot length, with a typical value of 0.625 ms corresponding to 1600 hops/second). Beacon periods are aligned to the slot structure of the home piconet of the node concerned, and are defined by the periods where the most significant bits of the piconet master clock, bits 27 . . . k, are constant. (This assumes that the 28-bit clock counter of Bluetooth is used. Namely, the counter steps twice in each slot.) k is a constant here that determines the length of the beacon period: T_{BCN}=2^{k-1}Tₛ. The minimum value of k that can be used is k=3 (T_{BCN}=4Tₛ) , but practical values are likely to be higher, e.g. k=11 (T_{BCN}=1024Tₛ).

In this example embodiment, one slot in each beacon period is chosen according to the following requirements:

The position of the beacon slot within the beacon period is derived from the MAC address of the node itself and clock of the master of the node's home piconet. In this way, other nodes can also determine the position knowing the address and the home piconet clock of the node.

The position of the beacon slot within the beacon period must be pseudo-random.

All positions with respect to the beacon period should be used with uniform distribution over the long term.

Subsequent beacon periods should not use the same position repetitively.

The set of beacon slots for a given beacon period must be the subset of the beacon slots for a shorter beacon period.

The frequency to be used in the beacon slots is not necessarily selected according to the home piconet's hopping sequence. Instead, it is derived from the clock of the home piconet and address of the node itself, and one of a total of N_{BCN} frequencies is selected in a pseudo-random way. N_{BCN} is the number of beacon frequencies, and it is a parameter of the protocol. (Possible values can be 79, 32, 16, 8; 79 being the number of existing channels specified in Bluetooth and 32, 16, 8 being arbitrary values that are powers of two.)

The parameter T_{BCN} is included in the beacon messages. This is necessary since all information (for example, the address of the node, the clock and master address of the home piconet, and the beacon period) must be included in the beacon packets so that the timing of future beacons can be predicted. This means that if a node needs to update the status information about a neighbour, it can predict the time when the next beacon packet is sent. Even if the timing synchronisation is not accurate, it still reduces the time when the beacon can be expected. A node is guaranteed to send beacon packets in its beacon slots, but it can also send beacon packets more often. In this way, nodes that send or receive traffic can be made more quickly discoverable.

Beacon packets have priority over baseband data packets, and so they interrupt data transmission. This means that two communicating nodes may lose a data or acknowledgement packet when one of the nodes sends a beacon packet. When the data transmission is on a different hopping sequence to the home piconet of a communicating node, then the slot synchronisation of the data transmission and that of beacon packets are different. The result of this is that a single beacon packet may force the node to leave out two slots in the data transmission, which can cause the loss of two data or acknowledgement packets. To alleviate the problem, nodes have the possibility of predicting the beacon packets in advance and leave these slots out during a data transmission.

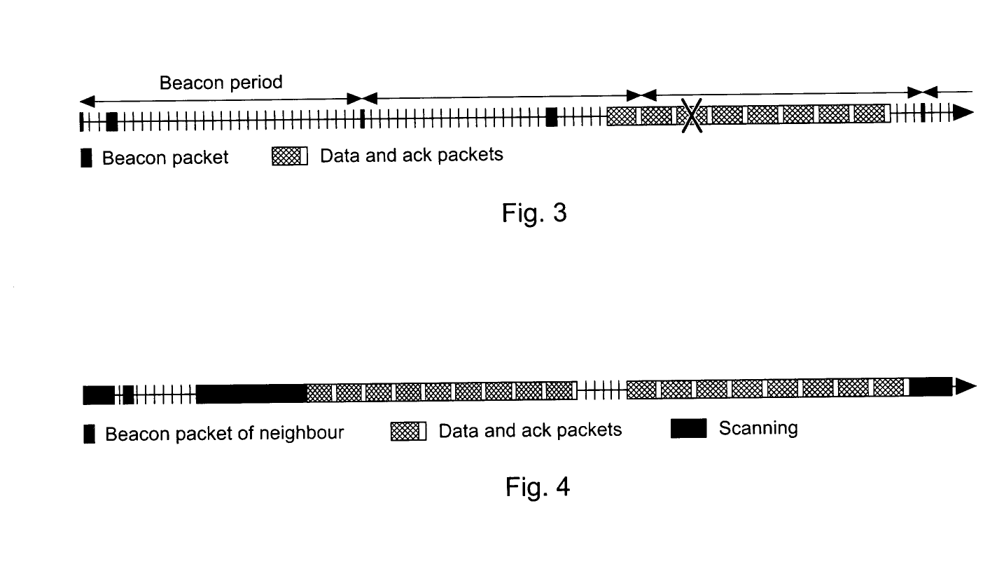

FIG. 3 illustrates beacon periods and beacon packets. As shown by the Figure, a beacon packet may coincide in time with a data transmission. In this case, a data packet may be lost unless the communicating nodes predict the position of the beacon packets in advance and leave out the corresponding slot.

Neighbour Management

In order to send data, the transmitter node needs to discover the MAC address of the destination first. In addition, timing information or other status information is beneficial. In embodiments of the present invention, this information is based on the beacon packets sent by the nodes.

Using the beacon packets of neighbours, the neighbour management protocol can discover new neighbours, update their status and discover the absence of old neighbours. In the case of status update (also referred to as re-synchronisation), a node can predict in advance when the beacon of a neighbour will be sent and can tune its receiver to the appropriate frequency using only a short receive window.

The disappearance of an old neighbour can be regarded as a special case of status update: a node is considered to be absent when its beacon packet has not been received for a threshold number of times (or for a given amount of time). The following description concentrates on the problem of neighbour discovery.

To discover its neighbours, each node performs scans. This means that for a period of time during which the node does not send or receive data, it scans for the beacon messages of its neighbours on one of the N_{BCN} beacon frequencies.

The scheduling and the length of the scan periods, or the frequency used for scanning are not specified. Any implemention of the present invention has the freedom to implement any scheduling and length of the scan periods based on the application requirements. In principle, the longer and the more often a node performs scanning, the quicker it can discover its neighbours. The frequency used for scanning does not significantly affect the neighbour discovery performance. The exact timing and frequency used can vary between implementations, and it can be based on the application needs in a trade-off between discovery speed and overhead of scanning.

The following are some example implementations. One possibility is to perform scanning regularly for a period of T_{scan} in a time window of T_{w}. Another possibility is to modify this rule when the node is actively sending or receiving, and perform scanning for a period of T_{d} between two data packets. It is also possible that a node is looking for a specific device, and it may be performing scanning continuously until that device is found (or some other condition is met). The frequency used for scanning can be determined in a pseudo-random manner based on the clock and address of the node.

FIG. 4 shows a node performing scanning while at the same time (in a time multiplexed fashion) it is transmitting or receiving data packets. The FIG. shows the beacon packets of a neighbour which is not using the same slot synchronisation. In the example, the beacon packet of the neighbour has not coincided in time with a scanning period of the node, which means that the neighbour has not yet been discovered. (Of course the two nodes must meet both in time and frequency in order to make discovery possible).

Certainly, this procedure does not guarantee a maximum time for the discovery of a neighbour. Instead it provides a very simple and flexible way of performing neighbour discovery and maintenance, where the probability of discovery increases monotonically as a function of the amount of time spent with scanning.

A simple analysis of the probability of discovery as a function of the time spent with scanning is given later and a summary of that analysis is given below. The way scanning is split up into scanning periods does not significantly influence the performance of scanning. It is also possible to show that it takes approximately 3 sec of scanning to discover with a probability of 90% an active node using a beacon period of 64 slots and 32 beacon frequencies. The probability of discovery tends to 1 exponentially with the amount of time spent with scanning, so that the probability of discovery in the example can be increased to 99% by prolonging the scanning to a total of 6 sec. The scanning does not need to be continuous, it is possible for the nodes to send or receive data between scan periods. This discontinuous scanning makes neighbour discovery very flexible.

Dynamic Adaptation of the Beacon Period

A node may adjust the value of its beacon period dynamically. There can be a wide range of algorithms for a dynamic setting. For example, when a node is active (has sent or received traffic in a given time-window), it may decrease the value of the beacon period to a small value so that it becomes quickly discoverable. When the node is not active (has not sent or received traffic in a given time window), it may increase the value of the beacon period, or it may even stop sending beacon packets completely, in which case it will not be possible to discover it. The dynamic adjustment of the beacon period is useful because it allows quick discovery of active nodes, and at the same time it saves the power of inactive nodes and also reduces interference caused by beacon packets.

When the neighbour has changed the setting of its beacon period to a larger value than previously, a specific problem may occur in the case of a status update (re-synchronization) of a neighbour. In this case the neighbour may not send a beacon packet when it is expected assuming the old beacon period. In this case, the status update can be repeated by increasing (by a factor of two) the estimated beacon period. After a finite amount or retries, the neighbour will be re-discovered. The beacon packet immediately updates the value of the beacon period.

Non-uniform Frequency Distribution

Instead of choosing the frequency of beacon packets so that all of the beacon frequencies occur with equal probability, it is possible to increase the probability of some of the frequencies and decrease the probability of other frequencies.

The advantage of this modification is that scanning can be performed more quickly by using one of the frequencies with higher probability. As a disadvantage, it is more likely that collisions can occur in the case of those frequencies.

Consequently, it is expected that an un-even distribution of beacon frequencies is advantageous in the case if a low density of devices, and it might not be advantageous in the case of a high density of devices.

Predictable Scanning Periods

Embodiments of the present invention makes it possible for nodes to perform scanning according to any scheduling principle, and the analysis below will show that the performance of neighbour discovery is not significantly influenced by the scheduling, only the total amount of time spent with scanning. Despite this fact, it may be advantageous for a node to make its scanning periods predictable. The reason for this is that during scanning, the node is not reachable in the piconet's hopping sequence. Therefore, it is advantageous for other nodes wishing to initiate a data transfer to know when the destination is not available.

One possible implementation of making the scanning periods predictable is to perform scanning of a period of T_{scan} in a time window of T_{w}. The beginning of the scan period within the time window can be based on the clock and address of the node (or alternatively its home piconet's master clock and master's address). By including the values of T_{scan} and T_{w} in the beacon packets, scan periods can be predicted in advance, and neighbours can avoid initiating a data transfer during scanning.

Note that the advertisement of the predictable scanning periods does not prevent the node from performing scanning at other times as well (even though those will not be predictable).

An alternative solution for the problem is to perform scanning when a node is otherwise not reachable. When a node goes to a power saving mode and is reachable only at certain time instants, it gives the possibility to perform the scanning for neighbours between these reachability instants so that the scanning periods do not influence the slots when neighbours can initiate a data transfer.

Additional Indicators in the Beacons

The beacon packets provide a means for transmitting additional information.

For example, every node may transmit an identifier of its application. This could be used for example to find access points and tell them apart from the beacon packets of laptops. In another example, beacon packets might contain IP addresses or URLs as well.

Another way of using beacons data is to include quality of service information. For example, information on the traffic load of the node can be sent. This makes it possible for nodes to choose the master of their home piconets to be the one with the least load.

Analytical Model

Presented here is a simple analysis of the time needed for neighbour discovery in a method in accordance with the present invention. The purpose is not to analyse the exact behaviour of such a method, but rather to arrive at a simple approximation of the relationship between probability of discovering a neighbour and the time spent scanning.

It is assumed that scanning is performed as follows. A node performs scanning on a given frequency for a period of T_{scan} repetitively, where the value of T_{scan} is at least 2Tₛ; Tₛ being the length of a timeslot. It is the intention to determine the probability of discovering a neighbour after the scanning is repeated many times, so that a total of Tₜₒₜ time has been spent with scanning. The frequency used for scanning is selected at random for each scan period. The neighbour node sends a beacon packet once in each beacon period of length T_{BCN}. The node performing the discovery has a beacon period of length T_{bcn}. Beacon packets are sent even during scan periods, interrupting the scanning.

Note that the parameters T_{scan} and Tₜₒₜ and T_{bcn} refer to the node performing the discovery, wile the parameter T_{BCN} refers to the node to be discovered. It must be kept in mind that in reality each node may be both subject to discovery and a node performing discovery.

To determine the probability of discovery in a single period of T_{scan}; the case of T_{scan}>=T_{BCN} is considered first. In a period of T_{scan} there are T_{scan}/T_{BCN} beacon packet signals. (This is an approximation since the first and last beacon signals might be missed due to the unsynchronised nature of the scan intervals and the beacon intervals. However the difference is minor and does not significantly affect the results). The probability of successfully detecting a beacon packet at the receiver, P₁, is determined as follows:

P₁=(1/Nᵣₑₛ) (1×2Tₛ/T_{bcn}) (1−Pₑᵣᵣ) (1)

Here the first factor (1/Nᵣₑₛ) gives the probability of using the same frequency for the scanning as for the beacon packet. The second factor takes into account that with a probability of 2Tₛ/T_{bcn} the beacon packet of the neighbour is not received due to the sending of the beacon packet which interrupts the scanning. Also taken into account is the possibility that the beacon packet is lost due to noise, fading or interference with a probability of Pₑᵣᵣ.

It is assumed that the three effects corresponding to the three factors are independent in successful beacons data packets. This is because the beacon frequency is selected in a pseudo-random fashion at both nodes and the errors are now assumed to be independent for simplicity.

The value of P₁ in some example cases is shown in the table below.

| Nᵣₑₛ | T_{bcn} | Pₑᵣᵣ | P₁ |
|---|---|---|---|
| 79 | 64 Tₛ | 0 | 0.012 |
| 32 | 64 Tₛ | 0 | 0.030 |
| 16 | 64 Tₛ | 0 | 0.060 |
| 8 | 64 Tₛ | 0 | 0.121 |

It follows that the probability of a successful discovery in a scan period of T_{scan} becomes

P_{scan}=1−[1−P₁]^{Tscan/TBCN} (2)

and the cumulative probability of successful discovery in Tₜₒₜ/T_{scan} consecutive scan periods, equal to a total amount of Tₜₒₜ scanning, is

P_{disc}=1−[1−P₁]^{Ttot/Tscan} (3)

Considering the case of T_{scan}<T_{BCN}, due to the random choice of the beacon packet timeslot and the arbitrary time position of the scan period, the probability of having a beacon packet in a scan period is modelled as T_{scan}/T_{BCN}. Using the assumption of independent scan periods (here it is assumed that scan periods are positioned randomly independently from each other), gives:

P_{disc}=1−[1−(T_{scan}/T_{BCN})P₁]^{Ttot/Tscan} (4)

Simple calculation can show that, as T_{scan} approaches zero, the limiting case of the formula becomes

P_{disc}=1−e^{P1 Ttot/TBCN} (5)

Comparing it with equation (3), the only difference is in the base of the exponent, which is the case of equation (5) , e^{-P}1=1−P₁+P₁²/2−K, while in equation (3) it is 1−P₁, meaning that the difference is in the order of P₁²/2. When the probability P₁ is small (in this case it is 0.12 or below), then the change in the base of the exponent as T_{scan} goes from T_{BCN} to 0 is less than 0.0144. In the following a typical set of parameters is used where P₁ is below 0.12, and therefore the change in the base of the exponent is not significant. For simplicity, equation (3) is used to compute the probability of discovery even in the T_{scan}<T_{BCN} case. Note that the equation does not include T_{scan} which implies that its choice does not influence the performance of the scanning procedure significantly. This shows that the performance of scanning is determined primarily by the total length of the scanning, and not how it is divided into scanning periods.

Numerical Results

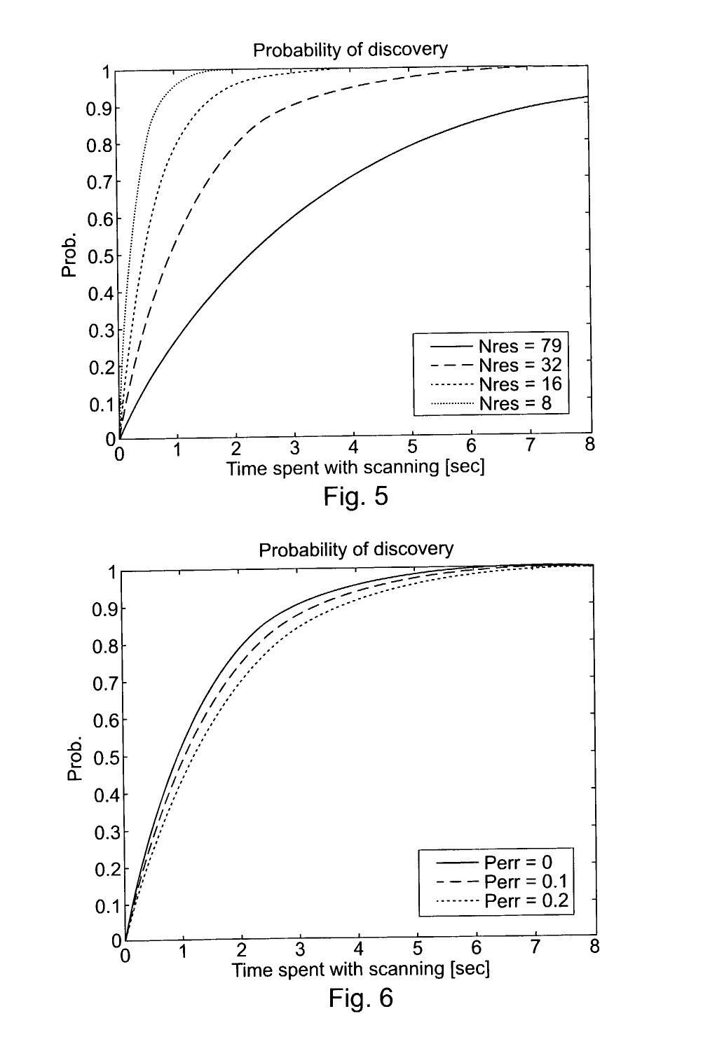

In the following some numerical results are given based on the analysis above. FIG. 5 shows the cumulative probability of discovering a neighbour as a function of the time spent with scanning. (As noted above, the value of T_{scan} does not significantly influence the results.) The following parameters were used: T_{bcn}=64Tₛ, T_{BCN}=64Tₛ Pₑᵣᵣ=0. This corresponds to an error-free environment with active nodes sending a beacon at least once in a period of 40 ms. The curves are parameterised with the number of beacon frequencies Nᵣₑₛ set to 79, 32, 16, 8. It can be observed that the probability of discovering exponentially goes to 1. The number of frequencies used for beacons has a significant influence on the time needed for discovery.

From equation (3) it is straightforward to determine that the time needed to discover a neighbour with a probability of 90% is

$${T}_{90} = {T}_{BCN} \frac{log 0.1}{log ( 1 - {P}_{1} )} \qquad ( 6 )$$

The following table gives these values in this case:

| Nᵣₑₛ | T₉₀ |
|---|---|
| 79 | 7.46 sec |
| 32 | 2.99 sec |
| 16 | 1.47 sec |
| 8 | 0.71 sec |

In the following the setting Nᵣₑₛ=32 is used, same as the number of inquiry frequencies in Bluetooth. Note that with this parameter setting, it takes 2.99 sec to discovery neighbours with a probability of 90%. (Again, keep in mind that the time referred to is the time spent with actual scanning. If the node is transmitting or receiving data in the meantime, or performs any other task that interrupts the scanning, then these time intervals are increased accordingly.)

In FIG. 6 errors are introduced to the transmission of beacon messages: Pₑᵣᵣ is set to 0.01 and 0.2. The other parameters are unchanged: T_{bcn}=64 Tₛ T_{BCN}=64Tₛ Nᵣₑₛ=32.

The table below also shows that the time needed to reach 90% probability discovery changes slightly:

| Pₑᵣᵣ | T₉₀ |
|---|---|
| 0 | 2.99 sec |
| 0.1 | 3.33 sec |
| 0.2 | 3.76 sec |

Below is listed the values of T₉₀ in some practically possible combinations of beacon period at the node to be discovered, T_{BCN}, and at the node performing discovery, T_{bcn}. The parameters Pₑᵣᵣ=0, Nᵣₑₛ=32, Tₛ=1/1600 sec are fixed.

| T_{90 =} | T_{BCN}/Tₛ = 16 | T_{BCN}/Tₛ = 64 | T_{BCN}/Tₛ = 1024 |
|---|---|---|---|
| T_{bcn}/Tₛ = 64 | 0.83 sec | 3.32 sec | 53.15 sec |
| T_{bcn}/Tₛ = 64 | 0.75 sec | 2.99 sec | 47.94 sec |
| T_{bcn}/Tₛ = 1024 | 0.73 sec | 2.91 sec | 46.51 sec |

The table shows that a very active node sending very frequent beacons (T_{BCN}/Tₛ=16) can be discovered very quickly, in under one second with 90% probability. An active node (T_{BCN}/Tₛ=64) can be discovered in under four seconds with 90% probability, and an inactive node (T_{BCN}/Tₛ=1024) can be discovered under one minute with 90% probability. This illustrates the trade-off between quick discovery and the amount of time spent with sending beacons. The length of the beacon period at the discovering node has only a moderate effect: the shorter it is, the longer the discovery becomes due to the increased number of interactions during scanning.

Summary of Analysis

The simple analysis above shows the probability of discovering a neighbour node as a function of the time spent with scanning. The analysis shows that the probability of discovery is strongly dependent on the total time spent with scanning, but the way this total time is split up into scanning intervals does not influence the results significantly.

In the case of an active node sending a beacon once in a beacon period of 64 slots, the node can be discovered in approximately 3 seconds of scanning time with a probability of 90%.

This shows that the present solution is very flexible in how nodes can perform neighbour discovery, yet it is efficient, because even in a short amount of time, approximately 6 sec, discovery can be made with a probability of 99% in the case of an active node.

Conclusion

It will therefore be appreciated that embodiments of the present invention can give a procedure by which the trade-off between the overhead of a neighbour discovery procedure and discovery time can be flexibly altered. The solution makes it possible to perform neighbour discovery even by an active node that is sending or receiving traffic. The solution lends itself well to easy implementation in the case of peer nodes when there is no a priori asymmetry in the roles of the devices. In addition, the solution provides a convenient way to transmit status information about a device that can be used by its neighbours.

1. A method of communicating connectivity information for a channel of a wireless communications system, the method comprising, in a node of the system using the channel:
transmitting a beacon signal which includes information identifying the node, the beacon signal being transmitted at a transmission timeslot, and on a transmission frequency;
scanning for beacon signals transmitted by other nodes using the channel, the scanning taking place on a scanning frequency range and scanning timeslot range; and
maintaining channel node connectivity information on the basis of received beacon signals, wherein at least one of the transmission timeslot and transmission frequency is determined in a pseudo random manner, or at least one of the scanning timeslot range and scanning frequency range is determined in a pseudo random manner.

2. A method as claimed in claim 1, wherein the transmission timeslot is selected from a predetermined time period.

3. A method as claimed in claim 2, wherein the predetermined time period is dynamically adjustable.

4. A method as claimed in claim 1 or 2, wherein the transmission frequency is selected from a predetermined frequency hopping sequence.

5. A method as claimed in claim 1, 2 or 3, wherein the transmission frequency is selected from a predetermined range of frequencies.

6. A method as claimed in claim 5, wherein each frequency in the range of frequencies has an equal probability of selection.

7. A method as claimed in claim 5, wherein the frequencies in the range of frequencies have a non-uniform uniform distribution of probabilities of selection.

8. A method as claimed in any one of the preceding claims, wherein the transmission timeslot is determined from a network access address and a network clock signal of the node.

9. A method as claimed in any one of claims 1, 2, 3 or 5 to 8, wherein the transmission frequency is determined from a network access address and a network clock signal of the node.

10. A method as claimed in any one of the preceding claims, wherein the wireless communications system is a short range radio frequency system.

11. A method as claimed in any one of the preceding claims, wherein the wireless communications system is a packet-based communications system.

12. A method as claimed in any one of the preceding claims, wherein the wireless communications system uses frequency hopping channels.

13. A method for communicating connectivity information for a channel of a wireless communications system, the method comprising, in a node of the system:
transmitting a beacon signal which includes information identifying the node, the beacon signal being transmitted at a transmission timeslot and on a transmission frequency, at least one of which is chosen in a pseudo random manner.

14. A method for communicating connectivity information for a channel of a wireless communications system, the method comprising:
scanning the channel to identify beacon signals from at least one node of the system, the beacon signal including information identifying the node;
receiving identified beacon signals; and
maintaining channel node information on the basis of received beacon signals,
wherein scanning of the channel takes place at a scanning timeslot and on a scanning frequency, at least one of which is chosen in a pseudo random manner.
